(19) United States
(12) Patent Application Publication
(10) Pub. No.: US 2013/0277312 A1
(43) Pub. Date: Oct. 24, 2013

(54) CAPILLARY ACTION WATER TREATMENT SYSTEM

(71) Applicant: NON SEQUITUR ENGINEERING GLOBAL (NSEG), Arvada, CO (US)

(72) Inventor: Robert O. Marquez, Las Cruces, NM (US)

(73) Assignee: Non Sequitur Engineering Global (NSEG), Arvada, CO (US)

(21) Appl. No.: 13/840,983

(22) Filed: Mar. 15, 2013

Related U.S. Application Data
(60) Provisional application No. 61/635,728, filed on Apr. 19, 2012.
(60) Provisional application No. 61/705,543, filed on Sep. 25, 2012.

(51) Int. Cl. C02F 1/28

(52) U.S. Cl. CPC C02F 1/28
USPC 210/662; 210/255; 210/253; 210/124; 210/669

(57) ABSTRACT

The present disclosure relates to systems and methods for water treatment. The disclosure provides systems that use a wicking material to modify the quality of contaminated water. The disclosure also provides methods for modifying the quality of contaminated water using a wicking material.

### RELATED APPLICATIONS

This application claims priority to and the benefit of U.S. Provisional Patent Application Ser. No. 61/635,728, filed on Apr. 19, 2012, entitled “ZERO ENERGY WATER TREATMENT SYSTEM BASED ON CAPILLARY ACTION”; and U.S. Provisional Patent Application Ser. No. 61/705,543, filed on Sep. 25, 2012, entitled “ZERO ENERGY WATER TREATMENT SYSTEM BASED ON CAPILLARY ACTION”; the disclosures which are hereby incorporated by reference herein in their entireties.

### BACKGROUND

Many underdeveloped or remote areas lack uncontaminated, potable water, even though there is an abundant supply of contaminated water. Many different technologies have been created over the years to clean contaminated water, however, these system typically are designed for use in developed countries and rely on complicated equipment, ongoing logistical or energy requirements, or trained operators. While some passive and portable treatment systems have been developed, these systems often are not scalable to provide large amounts of water to a local population.

Thus there is a need for a scalable, passive water treatment system that can supply clean water to a locality without requiring significant construction or ongoing oversight.

### SUMMARY

In one aspect, the present disclosure relates to a water treatment system to treat water, wastewater, industrial water, contaminated water found at remediation sites and the like. In another aspect, the present disclosure relates to modify water quality by treating or removing contaminants including, but not limited to, organic solids, sediments, organic matter, pathogens, and the like.

In one aspect, the present disclosure provides a water treatment system for treating contaminated water, wherein one or more first treatment vessels are receiving an initially treated water from an inlet and optionally discharging the initially treated water from an outlet followed by at least one or more second treatment vessels positioned below the one or more first treatment vessels, receiving a further treated water and discharging the further treated water from an outlet, further wherein a wicking filter material in the one or more first treatment vessels contacts the initially treated water and, via capillary action, pulls the initially treated water above the surface of the initially treated water to the edge of the one or more first treatment vessels and discharges the further treated water into one or more second treatment vessels. The water treatment system may be enclosed in a housing, wherein the housing has an access port through which spent wicking filter material is removed and new wicking filter material installed.

In yet another aspect, the present disclosure provides a water treatment system for treating contaminated water comprising a pre-filter treatment system receiving a flow of contaminated water and discharging an initially treated water followed by one or more leveling vessels receiving the initially treated water from the pre-filter treatment system. The water treatment system further comprises one or more first treatment vessels receiving the initially treated water from the one or more leveling vessels through an inlet and optionally discharging concentrated initially treated water from an outlet. Another one or more second treatment vessels is positioned below the one or more first treatment vessels, receiving a further treated water from the one or more first treatment vessels. A wicking filter material is placed in the one or more first treatment vessels and contacts the initially treated water and, via capillary action, pulls the initially treated water above the surface of the initially treated water to the edge of the one or more first treatment vessels and discharges the further treated water into the one or more second treatment vessels. The water treatment system may comprise one or more frames supporting the one or more leveling vessels, the one or more first treatment vessels and the one or more second treatment vessels.

In yet another aspect, the present disclosure provides a water treatment system for treating a contaminated water comprising one or more leveling vessels receiving a flow of contaminated water or initially treated water followed by one or more first treatment vessels receiving the initially treated water through an inlet and optionally discharging concentrated initially treated water from an outlet. Another one or more second treatment vessels is positioned below the one or more first treatment vessels, receiving a further treated water from the one or more first treatment vessels. A wicking filter material is placed in the one or more first treatment vessels and contacts the initially treated water and, via capillary action, pulls the initially treated water above the surface of the initially treated water to the edge of the one or more first treatment vessels and discharges the further treated water into the one or more second treatment vessels. The water treatment system may comprise one or more frames supporting the one or more leveling vessels, the one or more first treatment vessels and the one or more second treatment vessels.

In another aspect, the disclosure also provides a method of modifying quality of contaminated water, wherein a flow of initially treated water is produced by pre-filtering the contaminated water. The one or more first treatment vessels receive the initially treated water through an inlet and optionally discharges the initially treated water through an outlet wherein the one or more first treatment vessels comprises a wicking filter material. The initially treated water is then transported, via capillary action, using the wicking filter material in the one or more first treatment vessels to one or more second treatment vessels positioned below the one or more first treatment vessels wherein the one or more second treatment vessels receives a further treated water.

### BRIEF DESCRIPTION OF THE DRAWINGS

FIG. 1 illustrates a schematic view of an embodiment of a water treatment system.

FIG. 2 illustrates an enlarged side view of an embodiment of vessel positioning and placement of a wicking filter material.

FIG. 3 illustrates an embodiment of water treatment system vessels placed in a stacked configuration.

FIG. 4 illustrates an embodiment of water treatment system vessels placed in a staggered configuration.

FIG. 5 illustrates an embodiment of water treatment system vessels placed in a parallel stacked configuration.

FIG. 6 illustrates an embodiment of a water treatment system.

FIG. 7 illustrates an embodiment of a water treatment system.

FIG. 8 illustrates a schematic view of an embodiment showing a pre-filter intermodal unit placed above a treatment intermodal unit.

FIG. 9 illustrates a cross sectional view of an embodiment of a pre-filter intermodal unit and a treatment intermodal unit showing flow of contaminated water through a water treatment system

FIG. 10 illustrates an embodiment of a top view of a pre-filter intermodal.

FIG. 11 illustrates an embodiment of a cross-sectional view of pre-filter intermodal.

FIG. 12 illustrates an embodiment of a longitudinal side view of a treatment intermodal.

FIG. 13 illustrates an embodiment of a side view of the rear wall of a treatment intermodal.

FIG. 14 illustrates an embodiment of a top view of the treatment intermodal.

FIG. 15 illustrates an embodiment of a support frame.

FIG. 16 illustrates an embodiment of a support frame.

FIG. 17 illustrates an embodiment of a support frame.

FIG. 18 illustrates an embodiment of a support frame.

FIG. 19 illustrates an embodiment of a support frame.

### DETAILED DESCRIPTION

Before the water treatment systems are disclosed and described, it is to be understood that this disclosure is not necessarily limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a lithium hydroxide” is not to be taken as quantitatively or source limiting, and reference to “a step” may include multiple steps.

The same number represents the same element or same type of element in all drawings.

As used herein, the term “initially treated water” refers to contaminated water that reaches the first or introductory level of treatment trays or vessels for treatment. The term “further treated water” as used herein refers to one or more streams of water treated using a wicking material. For example, a second set of treatment trays or vessels may be positioned below the first set of treatment trays to receive further treated water from the first set of treatment trays or vessels. As another example, third set of trays of treatment trays or vessels receive a second further treated water from the second set of treatment trays or vessels, and so on.

The term hydraulically connected as used herein, refers generally to a hydraulic connection, for example, a hydraulic connection may describe a leveling tray connected with a hose or pipe to the one or more first treatment trays and the water level (height) in the leveling tray controls the level in the one or more first treatment trays.

The terms “vessels” and “trays” are used interchangeably. The terms “wicking filter material” and “wicking material” are used interchangeably. The wicking filter material is any material that transfers or transmits water, liquid or fluid via capillary action.

The term “contaminated water” refers to, for example, wastewater, industrial water, contaminated water found at remediation sites and the like that contains contaminants including, but not limited to, organic solids, sediments, organic matter, pathogens, and the like.

In one aspect, the present disclosure relates to a water treatment system to treat water, wastewater, industrial water, contaminated water found at remediation sites and the like. In another aspect, the present disclosure relates to modify water quality by treating or removing contaminants including, but not limited to, organic solids, sediments, organic matter, pathogens, and the like.

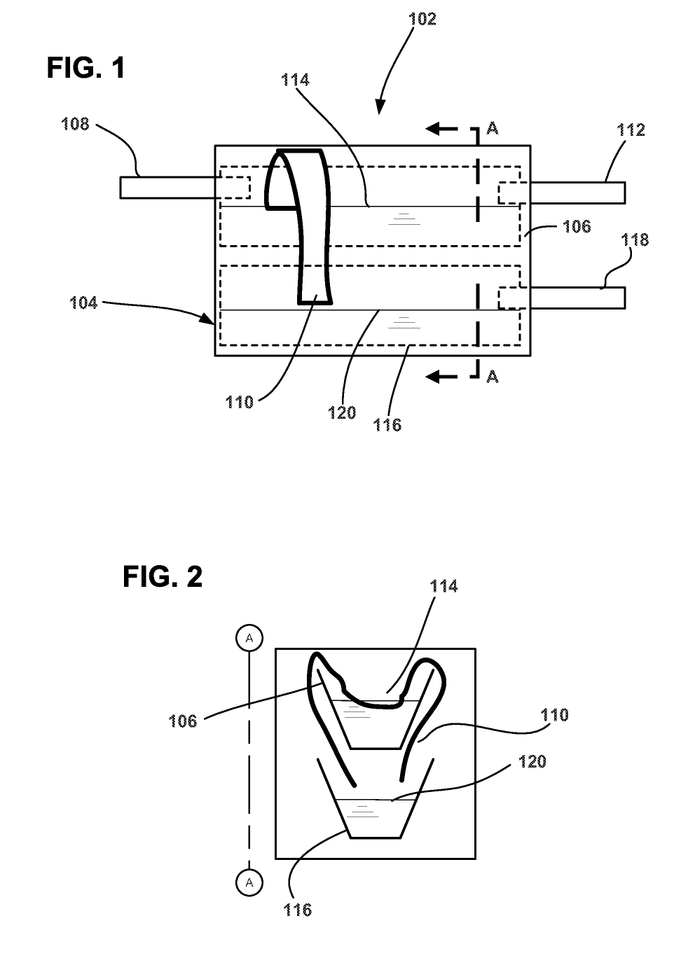

FIG. 1 and FIG. 2 (cross sectional side view of “A” in FIG. 1) illustrate an embodiment of a passive water treatment system that relies on capillary action to create a differential force that separates clean water from its contaminates. In the basic configuration of the embodiment shown in FIG. 1 and FIG. 2, the system 102 includes a housing 104, an inlet 108 for receiving a stream that forms a surface 114 of contaminated water (referred to within the water treatment system as initially treated water) to be treated, at least one outlet 112, 118 for discharging the concentrated initially treated water, concentrated reject stream or further treated water.

In one embodiment, FIG. 2 illustrates a side view of the system 102 disclosed in FIG. 1. Two treatment levels are shown with two treatment trays 106 and 116. In this embodiment, only treatment tray 106 is covered with a wicking filter material 110. The tray 106 receives contaminated water or initially treated water forming surface 114. The tray 116 receives a further treated water after treatment of initially treated water from tray 106. The further treated water in tray 116 forms surface 120.

Within the housing of the present embodiment, the initially treated water stream is treated by passing the stream through at least one tray or vessel containing a wicking filter material 110 that extends above the surface of the contaminated water. Further to this embodiment, the wicking filter material extends over the edge of the tray 106 and into a second set of trays or vessels 116. As discussed in greater detail below, the wicking material may be selected both to provide physical filtration of the water as well as to cause a stronger capillary force to be exerted on the water than on the dissolved contaminants in the water. The capillary action of the wicking materials causes water to be drawn into the filtering material, and into a second set of trays or vessels 116 resulting in the collection of clean filtered water (referred to within the water treatment system as further treated water) that forms surface 120.

In an embodiment, the housing 104 may be replaced by a structure to provide weather protection.

In an embodiment, separate outlets may be provided for the two sets of trays. The concentrated reject stream may be discharged from the first set of trays while the filtered water is discharged from the second set of trays as one or more further treated water stream. In an alternative embodiment, individual outlets may be provided for each tray or in some instances no outlets may be required to remove the concentrated reject stream.

In an embodiment, the first set of trays 106 may be located above the second set of trays 116 as shown in FIG. 1 and FIG. 2. In this configuration, a wicking material 110 provides sufficient capillary force to pull the water in the tray 106 from the water surface to the edge of the tray. After the water progresses over the edge of the tray 106, is driven by gravity to collect in the lower tray 116. In an embodiment, the first set of trays are considered a first treatment level and the second set of trays are considered a second treatment level. Each treatment level of vessels collect either the initially treated water or the further treated water, as the case may be.

Depending on the quality of the incoming water and the properties of the wicking materials 110 used, more than two treatment levels may be utilized. For example, a system may be provided with three treatment levels, four treatment levels, or more, such that water in each respective level is drawn and filtered by the wicking material to a next, lower level. In this way, a preferred water quality is obtained in the water collected in a final treatment level. The further treated water from the various intermediate treatment levels may be combined into a single discharge reject stream or may be discharged individually so that streams of different water quality may be used for different purposes.

If more than one tray is used in a treatment level, the trays may be hydraulically connected through a header or manifold so that each tray in the level has the same water level as the other trays. Such a manifold may be provided as part of the inlet 108 of the housing 104 for the first treatment tray 106, as part of the outlet 112 of the treatment tray 106 if the treatment tray has an individual outlet 112, or independent of the inlet and outlets at any location within the housing.

It should be noted that trays are but one way of creating a treatment level in which there is a volume for holding water and an edge or lip over which the wicking material 110 can draw clean water. In alternative embodiments, the various treatment levels of the system may be other than individual trays such as a single contiguous tray with multiple holes or slots provided with raised edges, much like a bubble-cap tray as used in distillation but with the caps removed and replaced with wicking material that extend from the storage area of the tray through the hole. Other configurations for treatment levels and complementary wicking material shapes are also possible and any suitable combination of shapes may be used.

Each treatment tray 106 and 1may be different in shape and configuration. For example, in a two treatment tray embodiment as illustrated in FIG. 1 and FIG. 2, the lower treatment tray 116 that receives the cleaned and filtered water may be a simple catch basin consisting of the bottom of the housing 104. In an embodiment, the trays of different levels may be offset. In another embodiment, the apertures between levels through which the wicking material penetrates may be aligned so that the wicking material is easily replaced and thus, for example, would not interfere with the operation of the wicking material in a treatment level beneath.

The system shown in FIG. 1 and FIG. 2 may be adapted to generate a desired flow rate of clean water from a source of contaminated water by adjusting such elements as the number of tray volumes, length of trays, number of wicking layers, and the wicking and filtration properties of the wicking material 110.

In an embodiment, the housings are modularly constructed so that multiple housings may be attached in series or in parallel to build additional capacity.

In another embodiment, the treatment performance for disclosed water treatment system or further treated water may be improved through addition of more treatment trays and levels. In another embodiment, the treatment performance for disclosed water treatment system or further treated water may be improved through adjustments to the filter material treatment. For example, some treatments may be introduced directly into the treatment trays of the water treatment system including, but not limited to, chemical addition, activated carbon, rusty nails, clay pellets, glass beads, etc. In an embodiment, the wicking filter material may be treated to remove desired or specific chemicals, while keeping those that are desired. In an embodiment, the wicking material and treatment of the wicking material may be fine-tuned depending upon the source water and desired outcomes.

The treatment system anticipates that the wicking material 110 will need to be replaced from time to time depending on the water quality of the water being treated and the wicking material used. In an embodiment, access to the wicking material 110 may be provided through an access port provided in the top of the housing 104. In an embodiment, the top of the housing 104 may be a hinged lid that may be lifted to expose the internals of the housing 104. Through this access, the used wicking material 110 may be removed and fresh material may be installed.

In an embodiment, in which different trays 106 and 116 are used to create an upper treatment level, as shown in FIG. 1 and FIG. 2, the wicking material 110 may be comprised of individual sheets of wicking material for each tray. In such an embodiment, each sheet may be of sufficient dimensions to cover the tray 106 and 116 surface and also extend from both sides of the tray 106 and 116 down to the treatment level below it. In an alternative, the wicking material 110 may be one large sheet with sufficient length so that it may be draped down through the spaces between the trays 106 and 116 of the level as well as cover the interior surface of the tray.

Different processes may be utilized for determining when wicking material 110 should be replaced. In an embodiment, the contaminated water to be treated may be tested on a bench, pilot, or full scale, in order to determine how long it takes for the wicking material 110 to become saturated or otherwise fouled to the extent that it should be changed. From this testing, a replacement schedule may be created and followed in the field. In an alternative embodiment, a mathematical model may be applied to analytical data for the contaminated water and a schedule determined from the results of the model. In yet another embodiment, active or passive water quality monitoring devices may be provided at an outlet 112 or 118 or outlets 112 and 118 in order to monitor the quality of the initially treated water and the further treated water. For example, upon determination that the quality of one of the discharge streams is out of compliance with a predetermined threshold for a stream, the wicking material 110 may be replaced.

In yet another aspect, the present disclosure provides a water treatment system 102 for treating contaminated water comprising one or more leveling vessels receiving a flow of contaminated water or referred to within the water treatment system as initially treated water followed by one or more first treatment vessels 106 receiving the initially treated water through an inlet 108 and optionally discharging concentrated initially treated water from an outlet 112. Another one or more second treatment vessels 116 is positioned below the one or more first treatment vessels 106, receiving further treated water from the one or more first treatment vessels 106. A wicking filter material 110 is placed in the one or more first treatment vessels 106 and contacts the initially treated water and, via capillary action, pulls the initially treated water above the surface 114 of the initially treated water to the edge of the one or more first treatment vessels 106 and discharges further treated water into the one or more second treatment vessels 116. The water treatment system may comprise one or more frames supporting the one or more leveling vessels, the one or more first treatment vessels 106 and the one or more second treatment vessels 116.

In another embodiment, the contaminated water is pretreated prior to treatment within a water treatment system. The pretreatment includes, but is not limited to, coarse solid screening to remove larger solids, or communition to shred debris, and optionally followed by grit removal. The grit removal may be performed utilizing grit chambers or by centrifugal separation of sludge. The pretreatment may also include pre-aeration of the contaminated water to add dissolved oxygen to prevent the odors of anaerobic decomposition. The pretreatment may be performed by flocculation. The pretreatment may also be performed by conventional filtration, free oil separation, equalization or any combination of any and all methods described here.

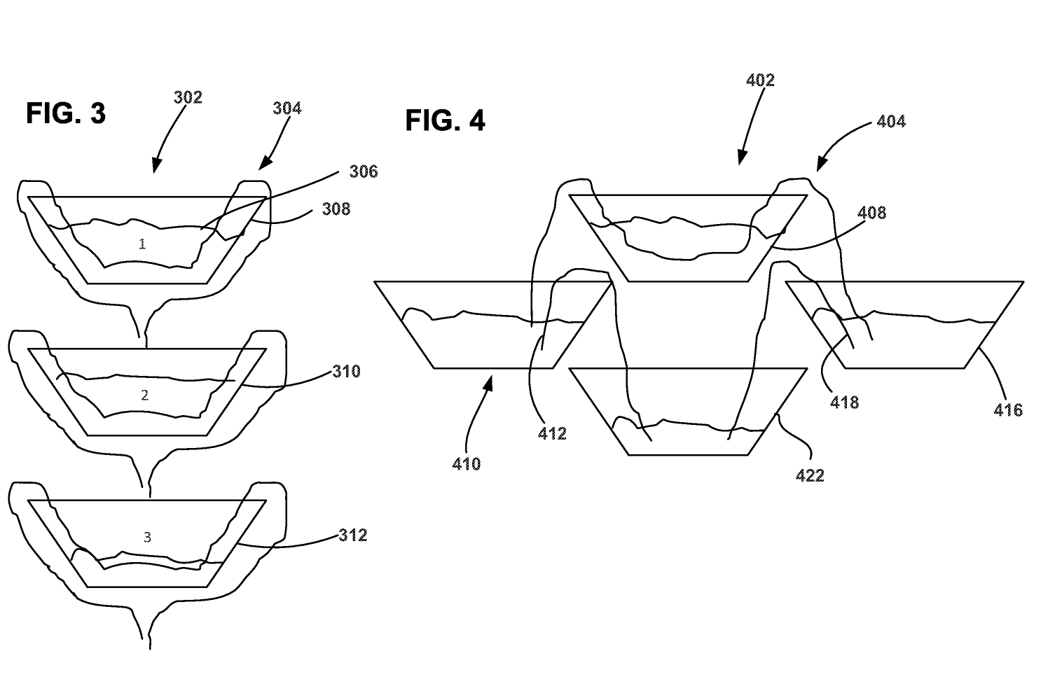

In an embodiment, a water treatment system 302 with multiple stages of trays may be used to improve water quality as shown in FIG. 3. In an embodiment, water quality for desired contaminant removal is improved from a tray 308 to tray 310, and further improved from tray 310 to tray 312. Further to this embodiment, 304 illustrate the wicking filter material, and 306 illustrate the initially treated water surface.

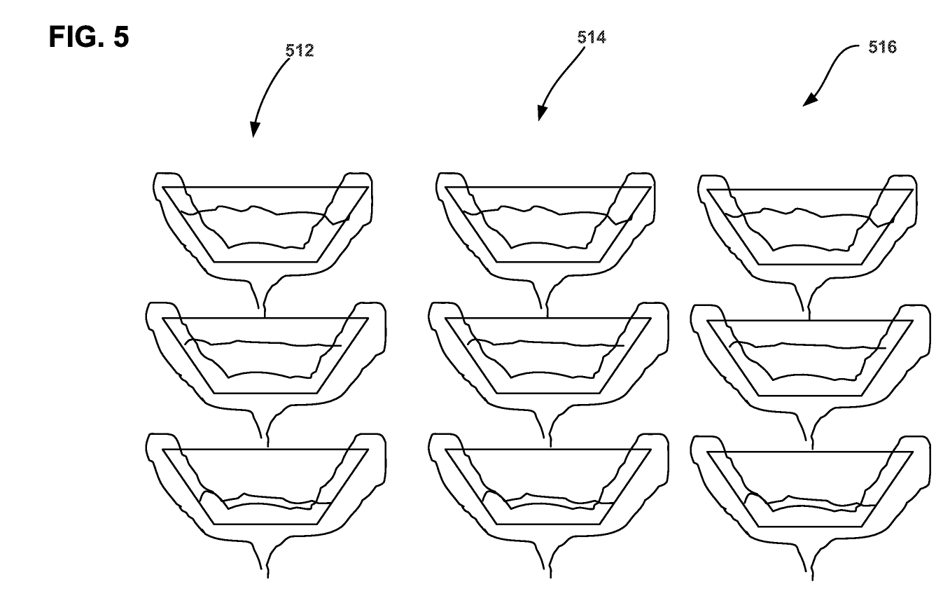

In another embodiment, a staggered water treatment system 402 may be used to fine-tune selective contaminant removal as shown in FIG. 4, wherein different wicking filter material 404, 418, and 412 may be used in different treatment trays 408, 416, 410, and 422 to selectively remove particular contaminant. The wicking filter material 404, 418, and 412 may be comprised of the same or different wicking material.

In yet another embodiment, a water treatment system with multiple stages in parallel may be constructed to fine-tune desired flow rate and to simplify maintenance. FIG. 5 illustrates a water treatment system, wherein 512, 514, and 516 illustrate stages of trays. In an embodiment, cleaning may require one stage of trays 512, 514, or 516 being taken offline.

In another embodiment, a treatment system may be automated or manually controlled for flow rate for purposes of cleaning and removal of solids, so that continuous operation of the treatment system is plausible.

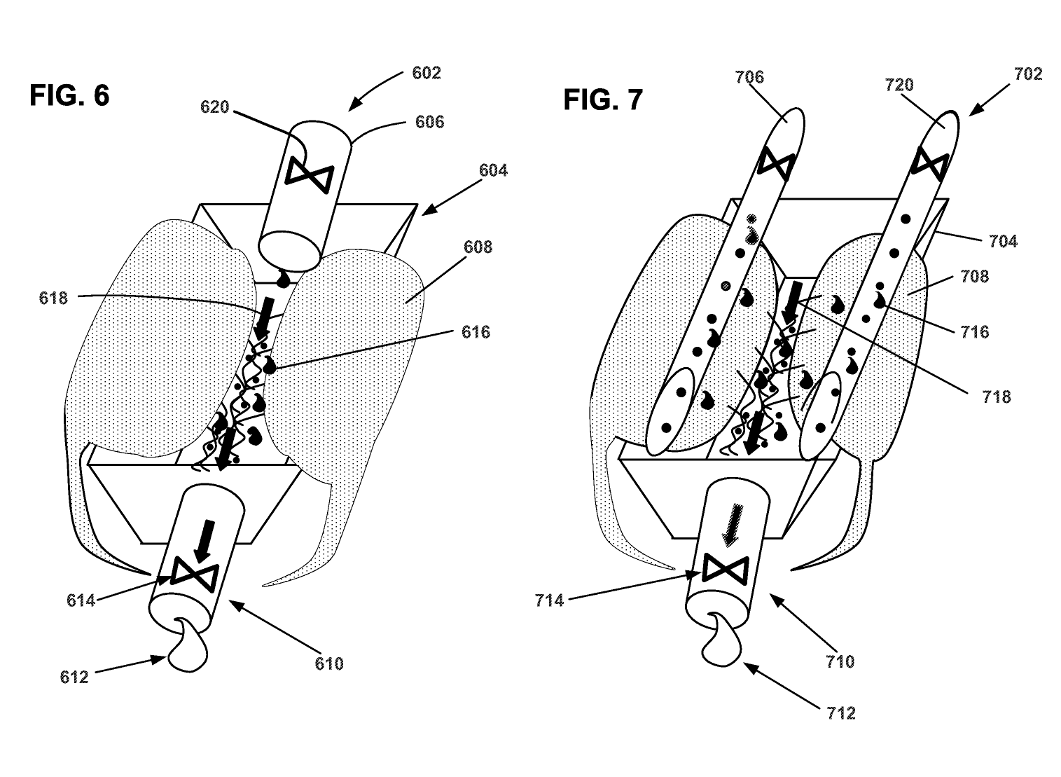

In an embodiment, valves 614 and 620 may be placed at the ends of the treatment tray 604 to a water treatment system 602 as shown in FIG. 6. The initially treated water enters through pipe 606 and exits through pipe 610. The valves at both ends may be opened simultaneously at high flow rates to allow the contaminants or solids 612 to flow out of the pipe(s) 610. Further to this embodiment, wicking filter material 608 is adjacent to pipe(s) 610 that show the direction 618 of the initially treated water flow. FIG. 6 further illustrates that the solids or other debris 616 is collected within the vessel 604.

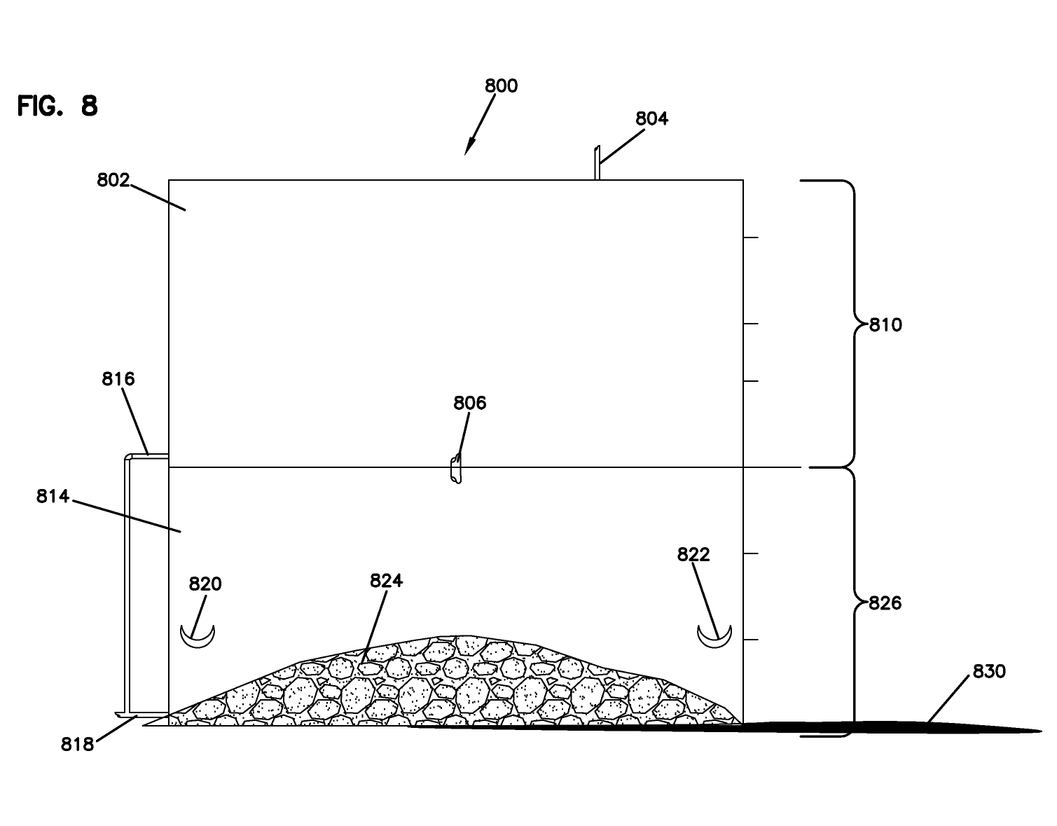

In another embodiment, a water treatment system 702 as shown in FIG. 7, the initially treated water 716 is introduced mid-way up the wicking filter material 708 using pipes 706 and 720 to allow solids to flow by gravity into the center of the treatment tray 704. The valve 714 in the pipe 710 may be periodically opened to allow for removal of the solids 712. Further, this configuration of initially treated water 716 introductions enables wicking to occur sooner, since the initially treated water 716 initially moistens the wicking filter material 708 mid-way up the gradient and thus allows for quicker start-up which is particularly useful for intermittent systems. Further to this embodiment, 718 refer to the direction of the initially treated water flow.

In another embodiment, the water treatment system 800 may be housed in one or more intermodals. For example, a water treatment system may be comprised of a treatment intermodal 814 and a pre-filter intermodal 802, as shown in FIG. 8. The pre-filter intermodal 802 may be placed above the treatment intermodal 814 in order to reduce overall treatment footprint. The purpose of the pre-filter intermodal 802 is to remove as much sediment, fines, and particulates from the wastewater as possible in order to reduce the maintenance requirements of the treatment intermodal. The pre-filter operations may require change out of pre-filter filtering material daily to weekly, depending upon the type of filter used. For example, cloth bags may be used as pre-filter material that are changed out daily to reduce the particulate load that reaches the treatment intermodal 814. A single ventilation fan may be used for both the pre-filter intermodal 802 and the treatment intermodals 814 in a stacked arrangement, e.g., by inserting a vent pipe 806 through the floor of the pre-filter intermodal 802 and through the roof of the treatment intermodal 814. The pre-filter intermodal 802 also has access doors 810. A combined airflow may then be vented through the vent 804 of the pre-filter intermodal 802. The intermodal 800 should be slightly sloped (0.01 ft/ft) with the help of sand fill 830 to ensure any leaks or drips in the treatment process may be routed through an overflow pipe 816 and 818, located adjacent to the floor of the pre-filter intermodal 802 and the treatment intermodals 814, back to a septic tank located outside of the water treatment system 800. The pre-filter intermodal 802 should be fitted with an access platform 812 in order to open doors 810 and gain access. The treatment intermodal also has access doors 826. The treatment intermodal 814 may have vents 820 and 822 to allow air flow into the treatment intermodal 814. In one embodiment, only the treatment intermodal 814 should have vents 820 and 822 to allow air flow into the intermodal 800. All vents may be covered with mosquito netting. The intermodal 800 may have a rubble berm 824 on both sides for hurricane protection.

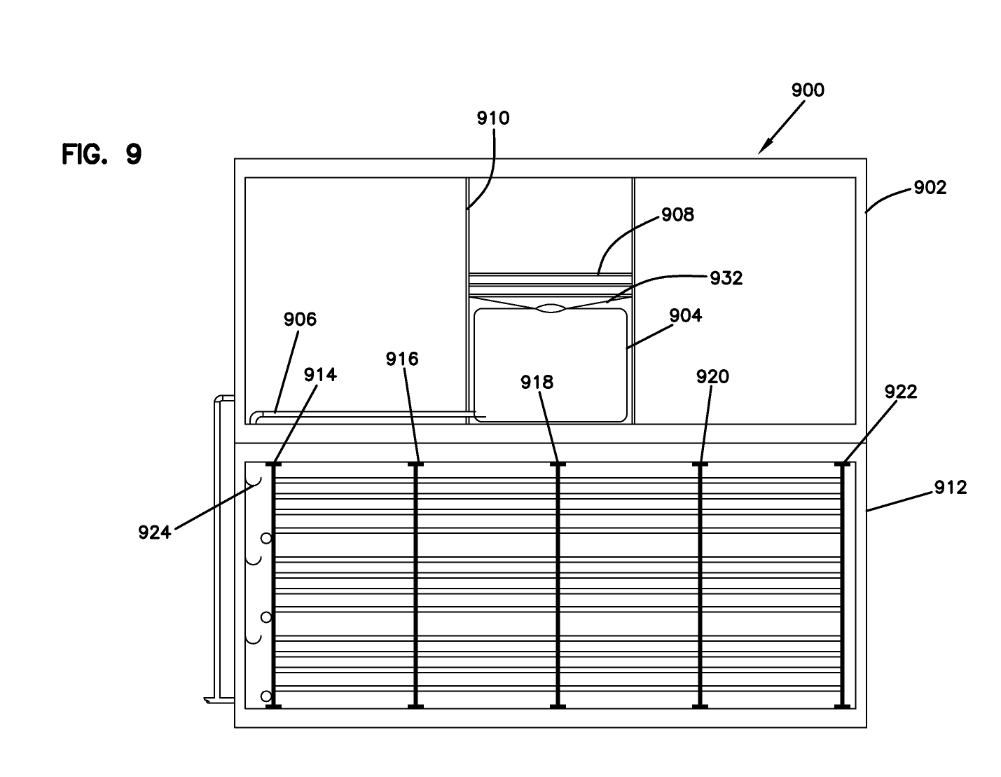

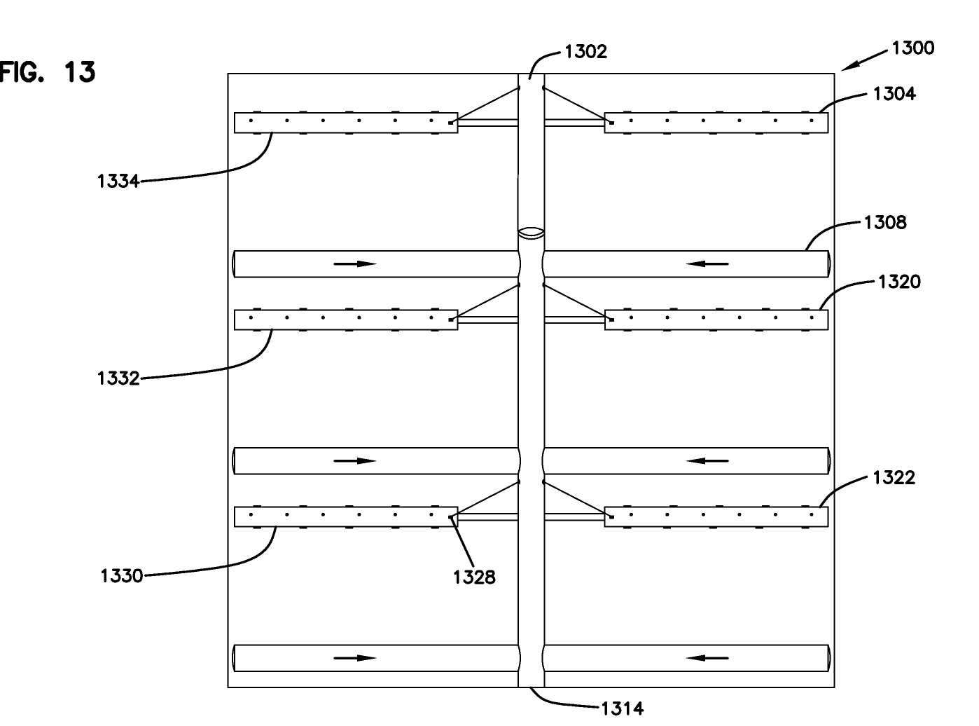

In one embodiment, FIG. 9 shows the cross sectional view of the water treatment system as shown in FIG. 8 in order to show the flow of contaminated water through intermodal 900. The contaminated water is passed through one or more pre-filters 908 and the pond liner 932, which are supported by the frame 910. The contaminated water is then stored in the equalization tank 904 in the pre-filter intermodal 902. The treatment flow rate from the equalization tank 904 is controlled by the float valves in the treatment intermodal 912 (See FIG. 13). The treatment intermodal 912 details the support frame A 914, frame B 916, frame C 918, frame D 920, frame E 922 that support the treatment and extraction trays detailed further in FIGS. 7, and 10-14. The contaminated water stored in the equalization tank is also called initially treated water of the pre-filter intermodal 902. The initially treated water is then introduced to the treatment intermodal 912 through connector 906, which is connected to the leveling tray 924.

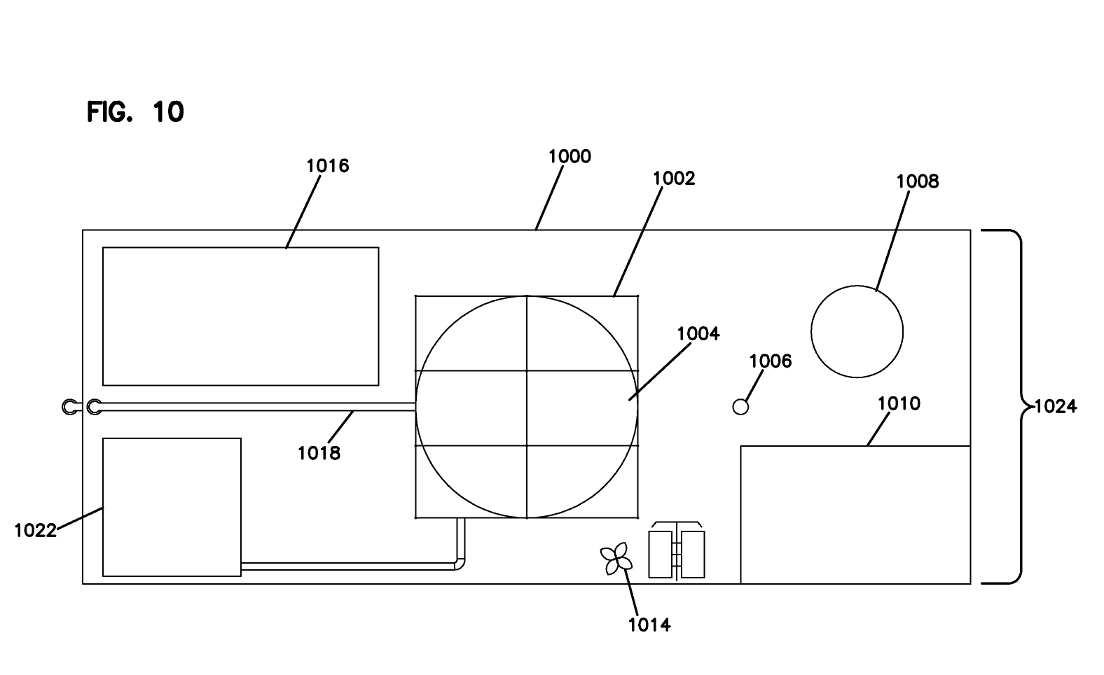

In one embodiment, the pre-filter intermodal shown in FIG. 10 shows a top view of pre-filter intermodal 1000. The location of the filter frame 1002 and equalization tank 1004 does not need to be in the middle of the pre-filter intermodal 1000. In one embodiment, the location is selected to be in the middle of the pre-filter intermodal to better maintain equilibrium. In one embodiment the filter frame 1002 is made of steel. In other embodiments, the filter frame 1002 may be made of other materials, and diameters, but should provide a stable platform for the pre-filter materials and allow for easy access for removal. In an embodiment, the contaminated water pump intake 1022, i.e., a septic tank, may also be placed outside of the pre-filter intermodal 1000, depending on the type of pumps available at the site. In one embodiment, the electric fan 1014 may be set up to push airflow out of the pre-filter intermodal 1000 through the vent 1006. The storage area 1016 for filter fabrics may be any type of locker that can keep the new filter fabrics from getting wet. The maintenance tank 1008 is to keep clean water onsite for clean-up purposes. The water lab 1010 is an optional feature should onsite water testing be implemented. The connector 1018 transports the initially treated water from the equalization tank 1004 to the treatment intermodal. The treatment intermodal also has access doors 1024.

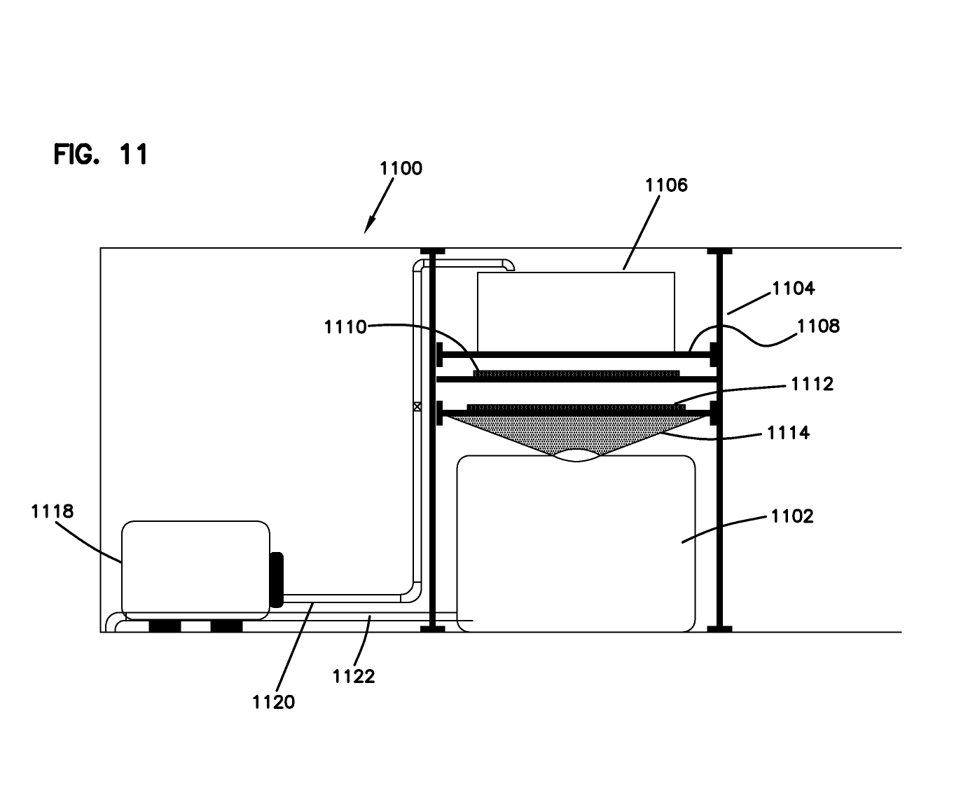

In one embodiment, the pre-filter intermodal shown in FIG. 11 shows the cross section of the pre-filter intermodal 1100. In one embodiment the filter frame 1104 is made of steel. In other embodiments, the filter frame 1104 may be made of other materials, and diameters, but should provide a stable platform for the pre-filter materials and allow for easy access for removal. In one embodiment, the equalization tank 1102 should be sized for approximately 60 minutes of treatment. In one embodiment, the contaminated water pump intake 1118 may also be placed outside of the pre-filter intermodal 1100, i.e. the septic tank, depending on the type of pumps available at the site. In one embodiment, delivery of the contaminated water to the pre-filters is accomplished through pipe 1120 and discharging of the initially treated water from the equalization tank 1102 to the treatment intermodal is accomplished through pipe 1122. In one embodiment, the pipes 1120 and 1122 are sized for the appropriate flow design.

In one embodiment, the contaminated water from 1118 passes through filters 1106, 1110, 1112, and pond liner 1114, and flows into the equalization tank 1102. Filter 1106 is supported 1108. Overflow from filters 1106 and 1110 flows to the filters positioned below. Any overflow from the filter 1112 may flow to the floor of the pre-filter intermodal 1100, which is slightly elevated. The contaminated water pump intake 1118 is slightly elevated. In one embodiment, the contaminated water pump intake 1118 is elevated at least 4 inches. In one embodiment, the filter 1106 has dimension 20 inches×48 inches W×48 inches L. In one embodiment, the filter 1110 has dimensions 50 inches×50 inches. In one embodiment, the filter 1112 has dimensions 53 inches×50 inches. In one embodiment, the equalization tank 1102 has 530 gallons of storage capacity.

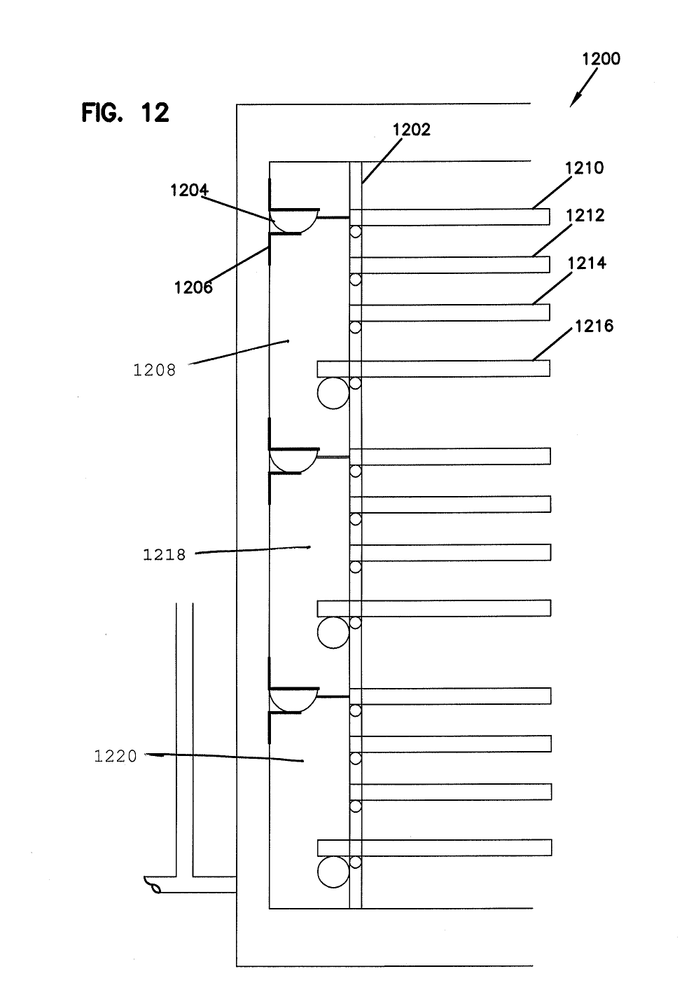

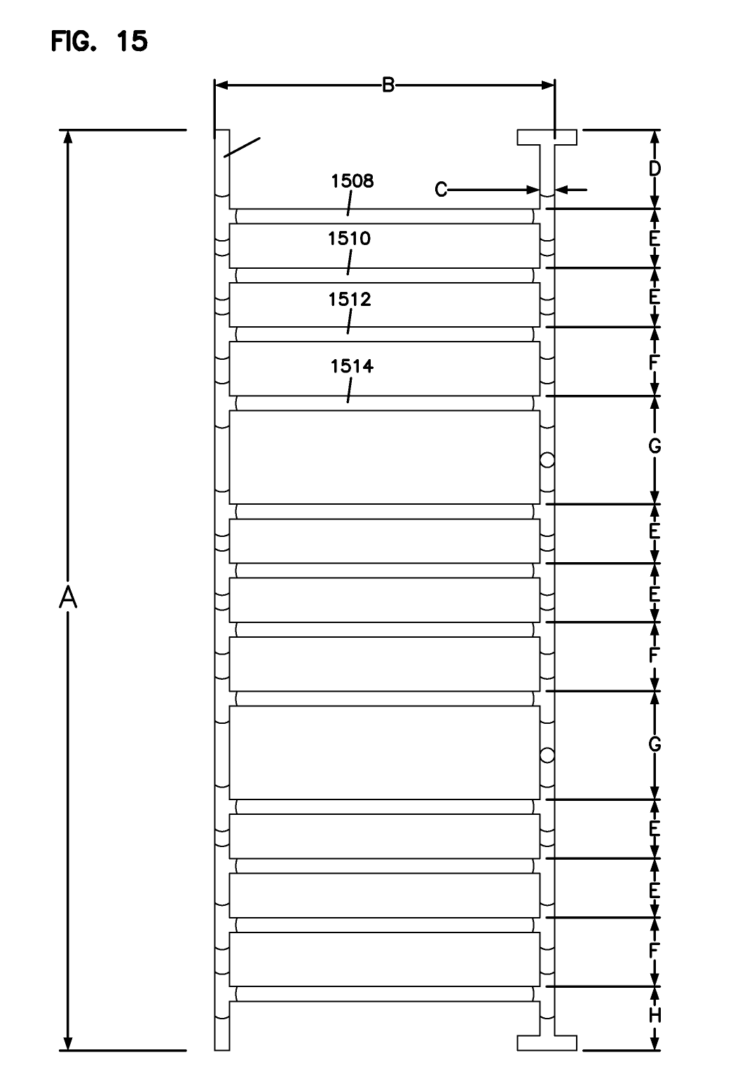

In one embodiment, the treatment intermodal 1200 has three separate treatment trains 1208, 1218 and 1220 as shown in FIG. 12, which shows the longitudinal side view of the treatment intermodal 700. Each treatment train comprises 3 treatment vessels and one collection vessel. Three treatment trains are shown, comprising a leveling tray 1204 that feeds water to a series of treatment trays or vessels 1210, 1212, 1214 and then to a collection tray or vessels 1216 for discharge. The leveling trays are supported by brackets 1206. Capacity of a water treatment system may be increased by adding more treatment trains, parallel sets of treatment and collection trays, or through the addition of more treatment material to the treatment trays. The treatment and the collection trays are supported by frame A 1202, shown in FIG. 12, and frames B, C, D, and E, shown in FIGS. 15-19. The initially treated water from pre-filter intermodal is introduced to the leveling tray 1204 which is operated by a float valve. The leveling tray 1204 is hydraulically connected to the one or more first treatment vessel 1210. In one embodiment, the leveling tray has hoses connecting to the first treatment vessels and the initially treated water flows out of the leveling trays by gravity into the one or more first treatment trays until the level is the same in all the one or more first treatment trays. In one embodiment, all treatment trays 1210, 1212, and 1214 have wicking filter material draped over the edges of the treatment trays such that the wicking filter material falls into the treatment tray positioned below without touching the water surface in the lower treatment tray. In another embodiment, the wicking filter material may touch the water surface below and may even be submerged into the water of the underlying treatment tray. In any of the configuration, the wicking material need only provide sufficient capillary force to pull the initially treated water in the one or more first treatment trays from the initially treated water surface to the edge of the tray. After the initially treated water progresses over the edge of the one or more first treatment tray 1210, is driven by gravity in to the one or more second treatment tray 1212 as further treated water. Thus, in this embodiment, the first set of trays may be considered the first treatment level and the second set of trays may be considered the second treatment level. Each post-first treatment level represents, generally, a volume of further treated water having a certain water quality that is connected through the wicking material to another volume of water having a different (i.e., improved) water quality. In this configuration, the further treated water from the one or more second treatment trays 1212 is treated in similar manner as above to provide a second further treated water to the one or more third treatment trays 1214. Similarly, the one or more third treatment trays 1214 provide a third further treated water to the one or more collection trays 1216. In an embodiment, the further treated water has turbidity of about less than 1 NTU, E coli reduction of about 4.2 log, and cryptosporoidium reduction of about 3.9 log.

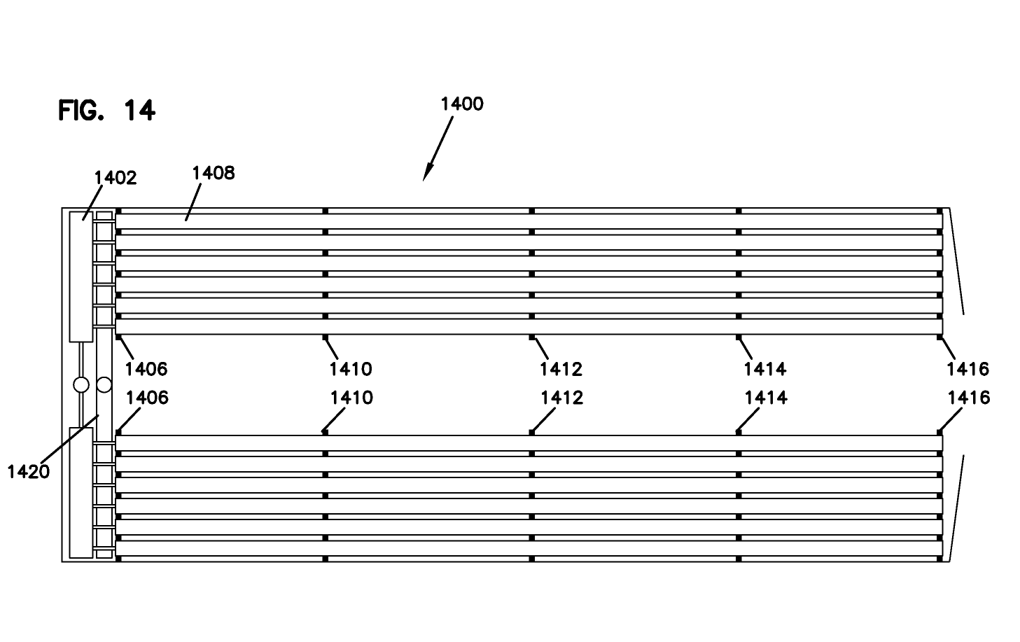

A side view of the rear wall of the treatment intermodal 1300 is shown in FIG. 13. In one embodiment, the initially treated water from the pre-filter intermodal is transported to the treatment intermodal 1300 through 1302 feeding six separate leveling trays, and each leveling tray is feeding initially treated water to six separate treatment trains. The leveling trays 1304, 1320, 1322, 1330, 1332, and 1334 are shown in FIG. 13. The number of treatment trays (collectively referred to by the term “train”) depends on the design flow, fabric selection, and number of layers of wicking material used per treatment tray. As shown in FIG. 14, each leveling tray has six collection tray ports, which are connected to six first treatment trays. A float valve such as 1328 is used to maintain the water level in each leveling tray and all connected first treatment trays. After treatment through all treatment trays, the collection trays feed further treated water into the horizontal further treated water collection pipes such as 1308. A manifold may connect all horizontal further treated water collection pipes to enable a single discharge pipe located at the bottom, center 1314.

A more detailed view of each of the leveling trays, as connected to six separate first treatment trays, in treatment intermodal 1400 is shown in FIG. 14. Starting from left center, an initially treated water pipe, positioned between leveling trays 1402, distributes contaminated water to leveling trays on each side, e.g., leveling trays 1402. Leveling trays 1402 are hydraulically connected to one or more of the six first treatment trays, e.g., first treatment trays 1408. In an embodiment, wicking filter material is placed in all extraction trays. A treatment flow rate may govern the type, weight, and number of layers of wicking filter material used. As described previously, initially treated water is driven into a second treatment tray through capillary action. Underlying second and third treatment trays continue the treatment and discharge to the collection trays. Collection trays are connected to a collection return pipe manifold 1420 for a common discharge. Collection and treatment trays are supported by Frames A, B, C, D, and E on each side referenced as 1406, 1410, 1412, 1414, and 1416 in FIG. 14. The frames differ by enabling a slope in the collection tray, so collected treated water can flow by gravity to a common collection pipe manifold 1420.

The frames discussed in FIG. 9 may be made of pipe, metal, wood, or plastic. FIGS. 15, 16, 17, 18 and 19 describe the individual frames A, B, C, D and E respectively. Each side of the treatment intermodal has its own support frames. Frames A through E are identical when supporting the treatment trays. Each frame decreases the gap between the collection tray and the third treatment tray by quarter (¼) inches progressing from Frame A to B, and so forth to Frame C, D, and E. The adjustable frame allows leveling of the treatment trays, but ensures a slope for the collection tray so treated water can flow by gravity to the further treated water collection manifold.

In embodiments, the frames A, B, C, D and E have the following measurements as shown in FIGS. 15, 16, 17, 18, and 19.

Values of frame A (FIG. 15): A is 7′-9.5″, B is 2′-10.5″, C is 1.5″, D is 8″, E is 6″, F is 7″, G is 11″, H is 6.5″, wherein 1508 is the first treatment tray, 1510 is the second treatment tray, 1512 is the third treatment tray, and 1514 is the collection tray.

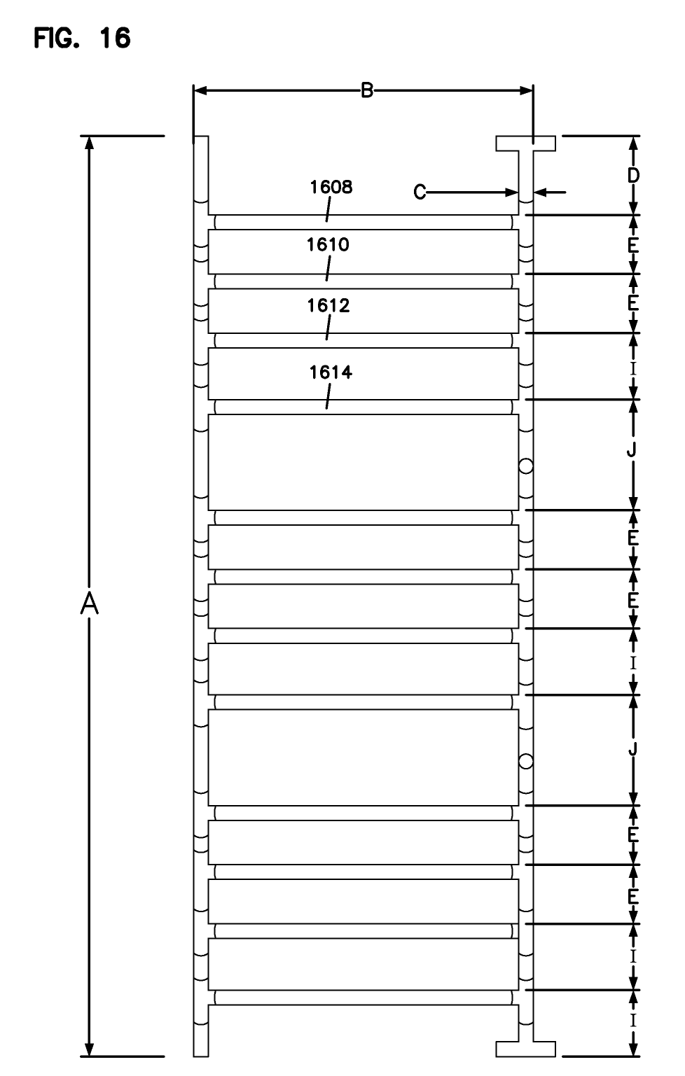

Values of frame B (FIG. 16): A is 7′-9.5″, B is 2′-10.5″, C is 1.5″, D is 8″, E is 6″, I is 6.75″, J is 11.25″, wherein 1608 is the first treatment tray, 1610 is the second treatment tray, 1612 is the third treatment tray, and 1614 is the collection tray.

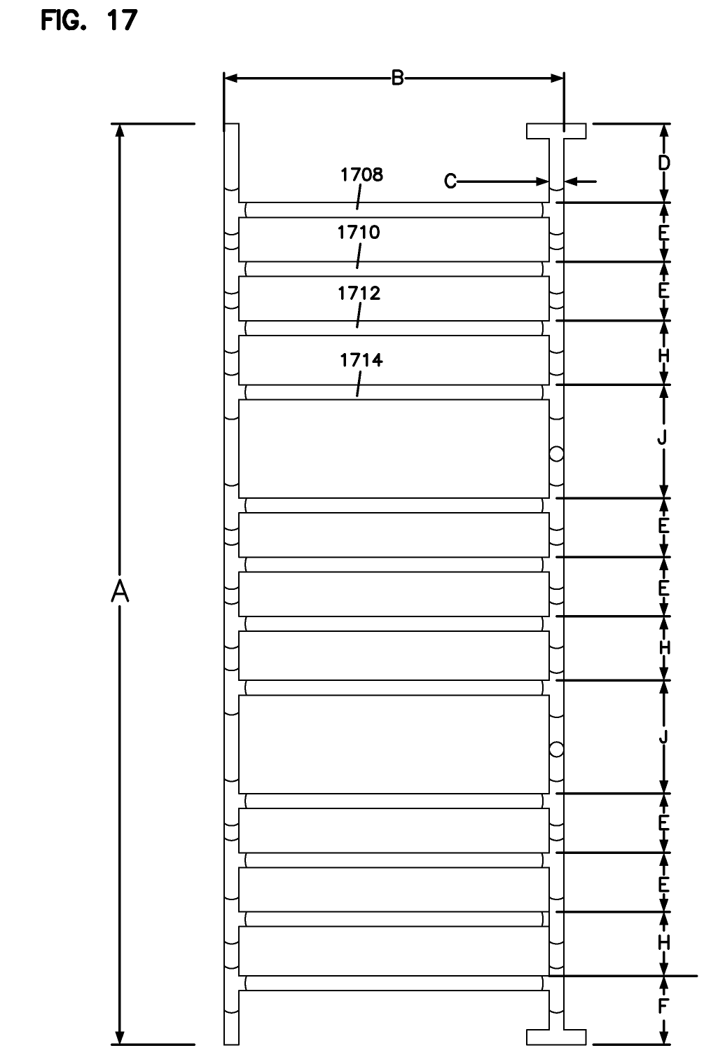

Values of frame C (FIG. 17): A is 7′-9.5″, B is 2′-10.5″, C is 1.5″, D is 8″, E is 6″, H is 6.50″, J is 11.50″, F is 7″, wherein 1708 is the first treatment tray, 1710 is the second treatment tray, 1712 is the third treatment tray, and 1714 is the collection tray.

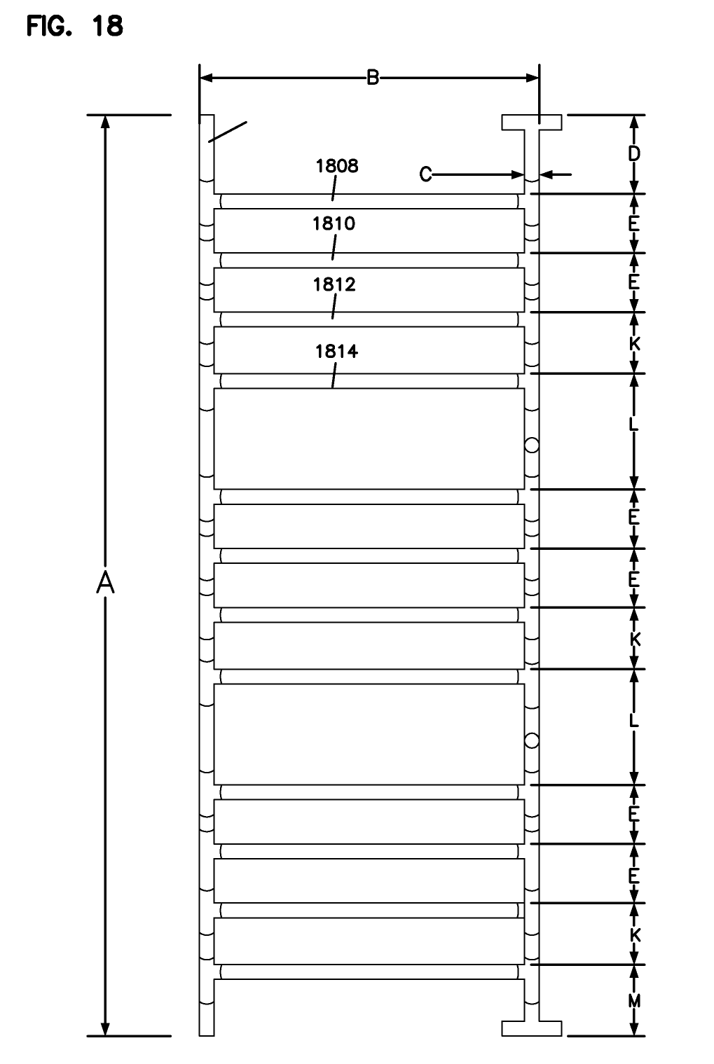

Values of frame D (FIG. 18): A is 7′-9.5″, B is 2′-10.5″, C is 1.5″, D is 8″, E is 6″, K is 6.25″, L is 11.75″, M is 7.25″, wherein 1808 is the first treatment tray, 1810 is the second treatment tray, 1812 is the third treatment tray, and 1814 is the collection tray.

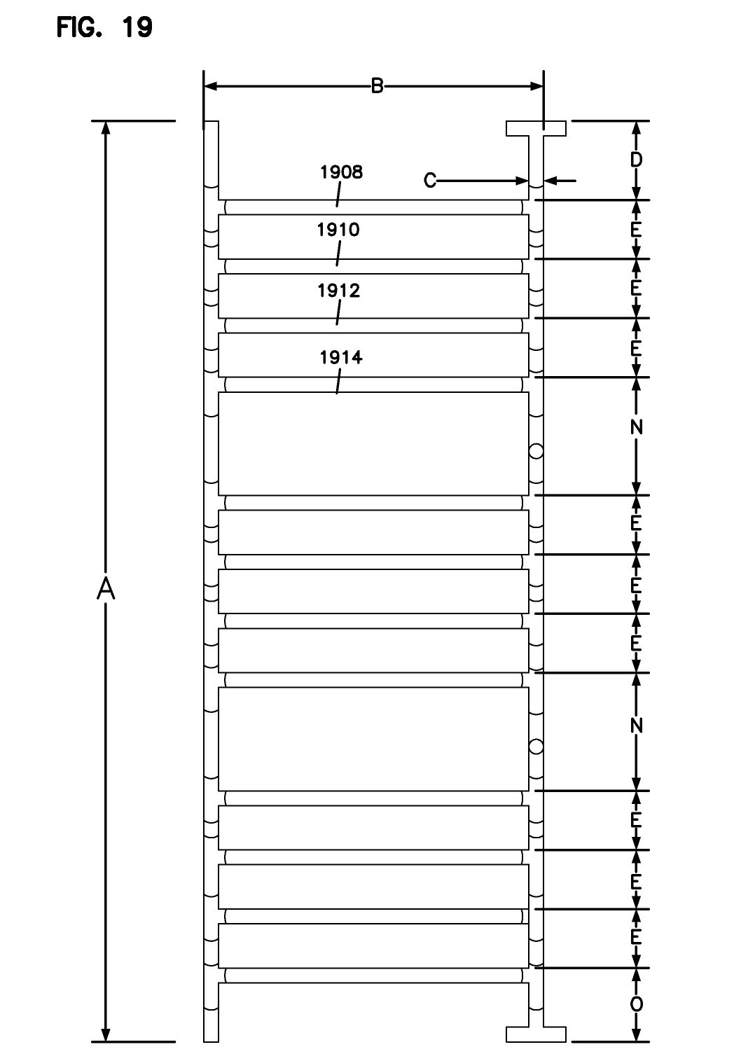

Values of frame E (FIG. 19): A is 7′-9.5″, B is 2′-10.5″, C is 1.5″, D is 8″, E is 6″, N is 1′, O is 7.5″, wherein 1908 is the first treatment tray, 1910 is the second treatment tray, 1912 is the third treatment tray, and 1914 is the collection tray.

The present disclosure also provides a method of modifying the quality of contaminated water, wherein the method comprises the steps of producing a flow of initially treated water by pre-filtering a contaminated water followed by receiving the initially treated water in one or more first treatment vessels through an inlet and optionally discharging the initially treated water through an outlet wherein the one or more first treatment vessels comprises a wicking filter material and transporting, via capillary action, the initially treated water using the wicking filter material in the one or more first treatment vessels to one or more second treatment vessels positioned below the one or more first treatment vessels wherein the one or more second treatment vessels receives further treated water.

In an embodiment, said method further comprises performing the steps of transporting, via capillary action, the further treated water using the wicking filter material in the one or more second treatment vessels to one or more third treatment vessels positioned below the one or more second treatment vessels wherein the one or more third treatment vessels receives a second further treated water; and

transporting, via capillary action, the second further treated water using the wicking filter material in the one or more third treatment vessels to one or more collection vessels positioned below the one or more third treatment vessels wherein the one or more collection vessels receives a third further treated water.

In an embodiment, said method has the inlet positioned at an upper portion of the one or more first treatment vessels.

In an embodiment, the method yields, or together may result in, the further treated water may have turbidity about less than 1 NTU, E coli reduction of about 4.2 log, and cryptosporoidium reduction of about 3.9 log.

In an embodiment, the method further comprises analyzing initially treated water quality and determining a desired further treated water quality followed by treating the wicking material to optimize the desired further treated water quality.

Table I illustrates the treatment results for a bio-chemical oxygen on demand concentration (BOD), total suspended solids concentration (TSS), nitrate concentration, total Kjeldahl nitrogen (TKN), and ammonia concentration of the initially treated water in the water treatment system and concentration of the further treated water (as described above) collected using one of the embodiments in the present disclosure.

TABLE I

| | | | Initially | Further | |
|---|---|---|---|---|---|
| | | | treated | treated | |
| Parameter | Test Method | L.O.Q.* | water | water | Units** |
| BOD | SM 5110B | 5.0 | 663.0 | 33.0 | mg/L |
| TSS | SM 2540C | 1.0 | 124.0 | 19.0 | mg/L |
| Nitrate (as N) | SM 4500-NO3- | 0.1 | 5.0 | 1.1 | mg/L |
| | Emod | | | | |
| TKN | EPA 351.2 | 1.0 | 48.0 | 39.0 | mg/L |
| Ammonia (N) | EPA 350.2 | 0.05 | 3.76 | 2.45 | mg/L |

*L.O.Q. = Limits of Quantitation
**Units = Units of Measurement of Results and L.O.Q.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

As used herein, “about” refers to a degree of deviation based on experimental error typical for the particular property identified. The latitude provided the term “about” will depend on the specific context and particular property and may be readily discerned by those skilled in the art. The term “about” is not intended to either expand or limit the degree of equivalents which may otherwise be afforded a particular value. Further, unless otherwise stated, the term “about” shall expressly include “exactly,” consistent with the discussions regarding ranges and numerical data. Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 4 percent to about 7 percent” should be interpreted to include not only the explicitly recited values of about 4 percent to about 7 percent, but also include individual values and sub-ranges within the indicated range. Thus, included in this numerical range are individual values such as 4.5, 5.25 and 6 and sub-ranges such as from 4-5, from 5-7, and from 5.5-6.5; etc. This same principle applies to ranges reciting only one numerical value. Furthermore, such an interpretation should apply regardless of the breadth of the range or the characteristics being described.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope of the described technology. Numerous other changes may be made which will readily suggest themselves to those skilled in the art and which are encompassed in the spirit of the disclosure.

1. A water treatment system comprising:
one or more first treatment vessels receiving an effluent from an inlet and optionally discharging the effluent from an outlet;
at least one or more second treatment vessels positioned below the one or more first treatment vessels, receiving an influent and discharging the influent from an outlet; and
a wicking filter material in the one or more first treatment vessels that contacts the effluent and, via capillary action, pulls the effluent above the surface of the effluent to the edge of the one or more first treatment vessels and discharges the influent into one or more second treatment vessels.

2. The water treatment system of claim 1, further comprising a housing or a structure enclosing the one or more first treatment vessels and the one or more second treatment vessels.

3. The water treatment system of claim 2, wherein the housing has an access port through which spent wicking filter material is removed and new wicking filter material installed.

4. A water treatment system comprising:
a pre-filter treatment system receiving a flow of contaminated water and discharging an effluent;
one or more leveling vessels receiving the effluent from the pre-filter treatment system;
one or more first treatment vessels receiving the effluent from the one or more leveling vessels through an inlet and optionally discharging the effluent from an outlet;
one or more second treatment vessels positioned below the one or more first treatment vessels, receiving an influent from the one or more first treatment vessels;
a wicking filter material in the one or more first treatment vessels that contacts the effluent and, via capillary action, pulls the effluent above the surface of the effluent to the edge of the one or more first treatment vessels and discharges the influent into the one or more second treatment vessels; and
one or more frames supporting the one or more leveling vessels, the one or more first treatment vessels and the one or more second treatment vessels.

5. The water treatment system of claim 4, further comprising:
at least one or more third treatment vessels positioned below the one or more second treatment vessels, receiving a second influent from the one or more second treatment vessels wherein the wicking filter material in the one or more second treatment vessels contacts the influent and, via capillary action, pulls the influent above the surface of the influent to the edge of the one or more second treatment vessels and discharging the second influent into the one or more third treatment vessels; and
at least one or more collection vessels, positioned below the one or more third treatment vessels, receiving a third influent form the one or more third treatment vessels wherein the wicking filter material in the one or more third treatment vessels contacts the second influent and, via capillary action, pulls the second influent above the surface of the second influent to the edge of the one or more third treatment vessels and discharges the third influent into the one or more collection vessels.

6. The water treatment system of claim 4, wherein the leveling vessel is hydraulically connected to the one or more first treatment vessels.

7. The water treatment system of claim 4, wherein each of the one or more first treatment vessels have same water level.

8. The water treatment system of claim 4, further comprising:
a housing enclosing the one or more leveling vessels, the one or more first treatment vessels, the one or more second treatment vessels, and the one or more frames, wherein the housing includes an access port through which spent wicking filter material is removed and new wicking filter material installed; and
wherein the housing further includes optional vents for managing airflow.

9. The water treatment system of claim 4, wherein the one or more leveling vessels comprise:
six (6) separate leveling vessels hydraulically connected to six (6) separate first treatment vessels.

10. The water treatment system of claim 4, wherein a water level in the one or more leveling vessels and the one or more first treatment vessels is controlled by a float valve.

11. The water treatment system of claim 4, wherein the pre-filter treatment system comprises:
at least one first pre-filter filtering material that receives the contaminated water from a septic tank, filters sediments, fines and particulates and discharges a first filtered flow of the contaminated water;
at least one second pre-filter filtering material positioned below the first pre-filter material receiving the first filtered contaminated water and discharging the effluent; and
at least one equalization tank positioned below the second pre-filter filtering material that receives the effluent.

12. The water treatment system of claim 13, further comprising:
a housing enclosing the pre-filter treatment system, the housing having an access port through which spent pre-filter filtering material is removed and new pre-filter filtering material is installed.

13. The water treatment system of claim 4, further comprising:
a ventilation fan;
a water pump;
a storage area for storing the pre-filter filtering material;
one or more vents exchanging air within the housing with air outside the housing; and
a maintenance tank containing clean water.

14. A method of modifying the quality of contaminated water, the method comprising:
producing a flow of effluent by pre-filtering a contaminated water;
receiving the effluent in one or more first treatment vessels through an inlet and optionally discharging the effluent through an outlet wherein the one or more first treatment vessels comprises a wicking filter material; and
transporting, via capillary action, the effluent using the wicking filter material in the one or more first treatment vessels to one or more second treatment vessels positioned below the one or more first treatment vessels wherein the one or more second treatment vessels receives an influent.

15. The method of claim 16, the method further comprising:
transporting, via capillary action, the influent using the wicking filter material in the one or more second treatment vessels to one or more third treatment vessels positioned below the one or more second treatment vessels wherein the one or more third treatment vessels receives a second influent; and
transporting, via capillary action, the second influent using the wicking filter material in the one or more third treatment vessels to one or more collection vessels positioned below the one or more third treatment vessels wherein the one or more collection vessels receives a third influent.

16. The method of claim 16, wherein the inlet is positioned at an upper portion of the one or more first treatment vessels.

17. The method of claim 16, wherein the influent, the second influent, and the third influent each independently have turbidity about less than 1 NTU, E coli reduction of about 4.2 log, and cryptosporoidium reduction of about 3.9 log.

18. The method of any one of claims 16 and 17, further comprising the steps:
analyzing effluent quality;
determining a desired influent quality; and
treating the wicking material to optimize the desired influent quality.
